(19) United States
(12) Patent Application Publication
(10) Pub. No.: US 2007/0223719 A1
(43) Pub. Date: Sep. 27, 2007

(54) Headphone for playing audio files

(75) Inventor: Kuan-Di Huang, Taoyuan County (TW)

Correspondence Address: BACON & THOMAS, PLLC, 625 SLATERS LANE, FOURTH FLOOR, ALEXANDRIA, VA, 22314, US

(73) Assignees: Kuan-Di HUANG, Taoyuan County (TW); HALLOA ENTERPRISE CO., LTD., Sanchong City (TW)

(21) Appl. No.: 11/393,740

(22) Filed: Mar. 31, 2006

(30) Foreign Application Priority Data
Mar. 6, 2006 (TW) 095107369

(51) Int. Cl. H04R 1/10; H04R 25/00

(52) U.S. Cl. 381/74; 381/384

(57) ABSTRACT

This invention is to provide a headphone for playing audio files which including a headband worn at a user's head, at least one speaker base, which includes a speaker, movably installed or fixed to an end of the headband for fixing at a position of the user's ear, a control circuit disposed in the speaker base and having at least one external interface, one main chip and one decoder, wherein the external interface is connected to a storage device, and the main chip is coupled to the external interface for reading an audio file stored in the storage device and generating a digital audio signal, and the decoder is coupled to the main chip for converting a digital audio signal into an analog audio signal and amplifying the analog audio signal to be outputted to the speaker.

### FIELD OF THE INVENTION

The present invention relates to a headphone, and more particularly to a headphone capable of playing audio files in many kinds of memory sticks and thumb drivers.

### BACKGROUND OF THE INVENTION

In recent years, digital music expands drastically as the digital music player (or walkman) market grows rapidly, and major international manufacturers including Apple, SONY, and many other well-known companies introduce various new models of products and new versions of music management software to gain their market share in the blooming market and try to lead others by promoting better products in such a severe competition. For example, Apple launched its “iPod Nano” digital music player whose storage medium is changed from a small hard disk drive of the iPod to a flash memory of the ipod Nano, so that the iPod Nano has a thickness of 6.9 mm and a weight of 42 g only and effectively achieves the objective for a light, thin, short and compact design. Such product comes with two models with a memory capacity of 4 GB and 2 GB, and their suggested retailing prices are USD 278 and USD 218 respectively (which fall within a range from NTD 7,500 to NTD 5,900). To win over the market share, SONY announced a “Walkman A” series of products including five new models of its products, and the major selling point resides on its intellectual song selecting function that allows user to search for the songs of the same singer or similar singers of the currently played song by shuffle as well as specifying a year range to search and play songs. There are three models of the products adopting a flash memory as the storage medium. The storage capacities of these three models are 2 GB, 1 G and 512 MB, and their suggested retailing prices fall within the range of JPY 22,000 to JPY 32,000 (which is about NTD 5,900 to NTD 8,600)

In general, flash memory is used as the storage medium of a digital music player. Although the capacity of a flash memory is not as large as a hard disk drive, the flash memory has the advantages of a smaller volume, a more-convenient-to-carry, and an easier-to-use features. At present, the memory capacity of the digital music player introduced by different manufacturers using a flash memory as its storage medium mainly falls in the range from 256 MB to 1 GB and these products have a suggested retailing price ranging from NTD 5,000 to NTD 10,000. Thus, general consumers may find the prices of these digital music players employing flash memory as their storage medium too high, and consumers may consider whether or not it is worth to pay a high price for the fun of listening to digital music, and such a high price becomes a determining factor for consumers to purchase a digital music player or give up the idea of purchasing the digital music player.

Besides the digital music player, various electronic consumer products including digital cameras, personal digital assistants and mobile phones are blooming in recent years, and thus the market of different memory cards for storing data, image and music data expands rapidly. At present, there are all types and specifications of memory cards sold in the market, and these memory cards are divided into large memory cards, medium memory cards and small memory cards according to the physical size of the card. The large memory cards and small memory cards are two major types, wherein the large memory cards include Multi Media Cards (MMC), flash memory cards (Compact Flash, CF), Secured Digital Card (SD), Smart Media (SM) and SONY Memory Stick (MS), and the MMC, CF and SD cards not only have a higher popularity in the market, but also become the main memory cards for digital cameras, MP3 players and other multimedia devices. Since the specifications of SD and MMC cards fit the requirements for miniaturizing smart phones, therefore SD and MMC cards become standard storage media adopted by major international mobile phone manufacturers including Samsung Electronics, Nokia and Motorola. The small memory cards include mini SD, Micro SD (T-Flash), RSMMC, MMC Micro, MS Duo and MS Micro (M2), etc. Since the small memory cards have the advantages of a light, thin, short and compact design, a power-saving, an easy-to-store and a repeatedly writing data features, small memory cards are used extensively in various different portable electronic products such as personal digital assistants (PDA), digital cameras (DSC), digital music players, and smart phones, etc. In different market segments, the small memory card has its advantage and leading position. Based on the foregoing reasons, many people have one or more memory cards for storing data of various different electronic products, and the memory cards have replaced floppy disks or optical disks. As a write-many portable storage medium, many computer manufacturers adopt several input/output interfaces for memory cards as a standard computer specification to facilitate users to read data from the memory cards.

Further, there is a storage medium with a popular name “thumb drivers” sold in the present market, which is provided for consumers to use and store digital data including data, images and music, etc. and almost each computer user has a thumb drivers. A user just needs to insert the thumb driver into a universal serial bus (USB) port of a computer to access data and files from the thumb driver through the computer.

As the extensive users of electronic consumer products already have at least one memory stick or thumb driver per person, consumers do not want to pay an additional high price to purchase a digital music player in order to listen to the digital music stored in the storage medium. Therefore, it is necessary to design a device that can be connected to a memory stick or thumb driver, so that users can read the audio files stored in the memory stick or thumb driver through such device and directly play the audio files. Thus, consumers do not have to pay an expensive price to buy a digital music player to listen to the digital music and can be free from being stumbled by cables. Furthermore, consumers can effectively avoid wasting money or resources to buy the same storage medium. The device of this sort becomes an important research and development subject for manufacturers to explore and study.

### SUMMARY OF THE INVENTION

In view of the shortcomings of the prior art digital music player that has disadvantages such as higher price, larger size and inconvenient-to-carry, the inventor of the present invention based on years of experience in the related industry to conduct extensive researches and experiments, and finally invented a headphone for playing audio files in accordance with the present invention, so that users just need to insert a storage device such as (various kinds of memory sticks or thumb drivers) into the headphone to read the audio files stored in the memory stick or thumb driver directly through the headphone, and users can listen to the music played from the headphone.

Therefore, it is a primary objective of the present invention to provide a headphone for playing audio files, and the headphone comprises at least one speaker base and a headband, and the speaker base is movably installed or fixed to an end of the headband, such that the speaker base will be fixed precisely at a position of a user's ear when the headband is worn at the user's head, and the speaker base or headband comprises a power supply device and a control circuit. The power supply device supplies electric power required for the operation of the control circuit, and the control circuit further includes an external interface, a main chip and a decoder, wherein the external interface is provided for inserting a storage device, and the main chip is coupled to the external interface for reading an audio file such as a MP3 file stored in the storage device, controlling the playback of the audio file, and sending a digital audio signal to the decoder. The decoder converts the digital audio signal into an analog audio signal and amplifies the analog audio signal and then outputs the analog audio signal to a speaker installed in the speaker base to produce a corresponding sound for users to listen to. The headphone is a digital music player that requires no storage medium (such as a flash memory) at all, and thus not only cutting down the manufacturing cost greatly, but also avoiding the waste of resources on installing the storage medium.

Another objective of the present invention is to further include a control panel disposed on the speaker base or the headband, and the control panel is coupled to the main chip, so that users can control the main chip directly to read or execute the audio file (including select, stop, play, forward and backward instructions) through the control panel, and thus the invention requires no additional component (such as a general external headphone, a signal line and a connectors, etc) at all, and users can listen to digital music easily.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of the invention;

FIG. 2 is a schematic circuit block diagram of the invention; and

FIG. 3 is a perspective view of another preferred embodiment of the invention.

### DETAILED DESCRIPTION OF THE PREFERRED EMBODIMENTS

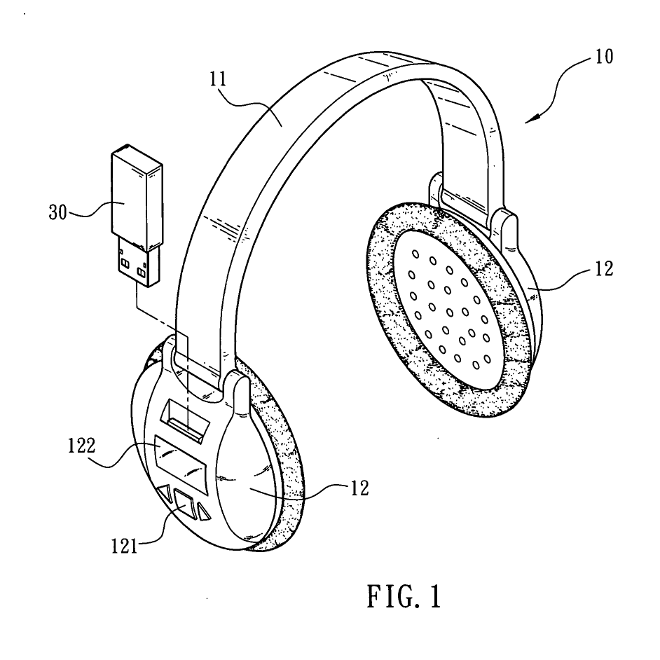

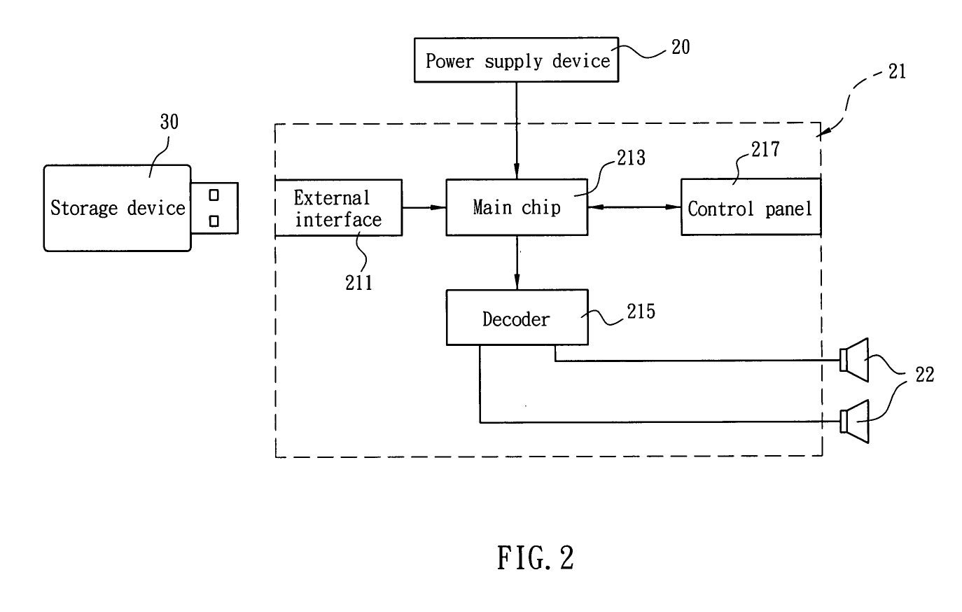

Referring to FIG. 1 for the preferred embodiment of a headphone for playing audio files in accordance with the present invention, the headphone 10 comprises a headband 11 and at least one speaker base 12. In the preferred embodiment of the present invention as shown in FIG. 1, the headphone 10 comprises a headband 11 and two speaker bases 12, wherein each speaker base 12 is movably installed or fixed to both ends of the headband 11, such that when the headband 11 is worn at a user's head, the speaker base 12 will be fixed precisely at a position of the user's ear, and the user can listen to the produced sounds through the speaker base 12. Referring to FIG. 2 for the preferred embodiment, each speaker base 12 contains a power supply device 20 and a control circuit 21, and the power supply device 20 is provided for supplying electric power required for the normal operation of the control circuit 21 and the control circuit 21 further comprises at least one external interface 211, a main chip 213 and a decoder 215, wherein the external interface 211 is provided for inserting a storage device 30 (such as different memory sticks and thumb drivers), and the main chip 213 is coupled to the external interface 211 for reading an audio file (such as a MP3 file) stored in the storage device 30, controlling the playback of the audio file, and sending the digital audio signal to the decoder 215. The decoder 215 converts the digital audio signal into an analog audio signal and amplifies the analog audio signal and then outputs the analog audio signal to a speaker 22 in each speaker base 12 to produce the corresponding sound.

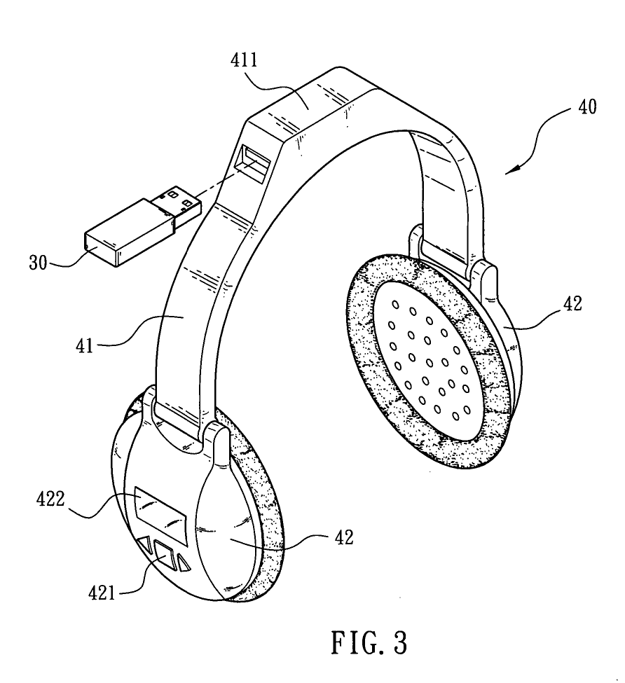

It needs to point out that the description above is provided for illustrating a preferred embodiment of the present invention only. In actual practices of manufacturing and designing the headphone of the present invention, only one end of the headband 11 is movably installed or fixed to a speaker base 12 depending on the actual needs, so that the headband 11 is worn at the user's head, and the speaker base 12 is fixed at a position of the user's ear, and the user can listen to the produced sound. through the single speaker base 12. Referring to FIGS. 1 and 2 for another preferred embodiment of the present invention, the power supply device 20 is installed in one of the speaker bases. 12, and the control circuit 21 is installed in another speaker base 12. Referring to FIGS. 2 and 3 for a further preferred embodiment of the present invention, the headphone 40 of the invention comprises a headband 41 and two speaker bases 42, wherein each speaker base 42 has only one speaker 22 for producing the corresponding sound, and the power supply device 20 and the control circuit 21 are installed in a containing space 411 of the headband 41 for providing the required electric power and inserting a storage device 30 (such as different memory sticks and thumb drivers) so that the main chip 213 of the control circuit 21 can read the audio file (such as a MP3 file) stored in the storage device 30 and send the generated digital audio signal to the decoder 215. The decoder 215 converts the digital audio signal into an analog audio signal, amplifies the analog audio signal, and then outputs the analog audio signal to a speaker 22 in the speaker base 42 to produce the corresponding sound. In the foregoing preferred embodiment, the power supply device 20 could be a regular battery or a rechargeable battery, or an external power adaptor for supplying external electric power and converting and supplying electric power to the control circuit 21.

In the foregoing preferred embodiment of the present invention as shown in FIG. 2, the control circuit 21 further comprises a control panel 217 coupled to the main chip 213 for controlling the main chip 213 to select and execute an instruction for the audio file stored in the storage device 30, and these instructions include “select”, “stop”, “play”, “forward” and “backward”. Referring to FIGS. 1 and 3 again, the control panel 217 comprises at least one press button 121, 421 and at least one liquid crystal display 122, 422, such that when a user presses the press button 121, 421 to execute an instruction (such as “select”, “stop”, “play”, “forward” and “backward”), the liquid crystal display 122, 422, will display the detail information of the audio file. Thus, the user can directly read and play the audio file stored in the storage device 30 (such as different memory cards and sticks) through the headphone of the present invention without purchasing a digital music player or worrying about being stumbled by the signal lines. Users can listen to digital music easily, not only effectively overcoming the inconvenience of carrying the digital music player, but also avoiding unnecessary waste of resources.

While the invention herein disclosed has been described by means of specific embodiments, numerous modifications and variations could be made thereto by those skilled in the art without departing from the scope and spirit of the invention set forth in the claims.

What is claimed is:

1. A headphone for playing audio files, comprising:
a headband, provided for wearing at a position at a user's head;
at least one speaker base, movably installed or fixed to an end of said headband, such that said speaker base is fixed at a position of said user's ear when being worn at said user's head, and said each speaker base includes a speaker therein;
a control circuit, disposed in said speaker base and having at least one external interface, one main chip and one decoder, and said external interface is connected to a storage device, and said main chip is coupled to said external interface for reading an audio file stored in said storage device and generating a digital audio signal, and said decoder is coupled to said main chip for converting a digital audio signal into an analog audio signal and amplifying said analog audio signal to be outputted to said speaker.

2. The headphone for playing audio files of claim 1, further comprising a power supply device installed in said speaker base or said headband and coupled to said control circuit for supplying electric power required for the normal operation of said control circuit.

3. The headphone for playing audio files of claim 1, wherein said control circuit further comprises a control panel coupled to said main chip for controlling said main chip to select and play an audio file stored in said storage device.

4. The headphone for playing audio files of claim 3, wherein said control panel further comprises a press button for a user to press for selecting, stopping, playing, forwarding, or rewinding said audio file.

5. The headphone for playing audio files of claim 4, wherein said control panel further comprises a liquid crystal display for displaying detailed information of said audio file.

6. A headphone for playing audio files, comprising:
a headband, provided for wearing at a position at a user's head and having a containing space thereon;
at least one speaker base, movably installed or fixed to an end of said headband, such that said speaker base is fixed at a position of said user's ear when being worn at said user's head, and said each speaker base includes a speaker therein;
a control circuit, installed in said containing space and having at least one external interface, one main chip and one decoder, and said external interface is connected to a storage device, and said main chip is coupled to said external interface for reading an audio file stored in said storage device and generating a digital audio signal, and said decoder is coupled to said main chip for converting a digital audio signal into an analog audio signal and amplifying said analog audio signal to be outputted to said speaker.

7. The headphone for playing audio files of claim 6, further comprising a power supply device installed in said speaker base or said containing space and coupled to said control circuit for supplying electric power required for the normal operation of said control circuit.

8. The headphone for playing audio files of claim 7, wherein said control circuit further comprises a control panel coupled to said main chip for controlling said main chip to select and play an audio file stored in said storage device.

9. The headphone for playing audio files of claim 8, wherein said control panel further comprises a press button for a user to press for selecting, stopping, playing, forwarding, or rewinding said audio file.

10. The headphone for playing audio files of claim 9, wherein said control panel further comprises at least one liquid crystal display for displaying the detailed information of said audio file.
